(19) United States
(12) Patent Application Publication
(10) Pub. No.: US 2017/0085841 A1
(43) Pub. Date: Mar. 23, 2017

(54) Image Recording System, User Wearable Device, Imaging Device, Image Processing Device, Image Recording Method And Storage Medium

(71) Applicant: CASIO COMPUTER CO., LTD., Shibuya-ku (JP)

(72) Inventor: Kazuaki HAGIWARA, Koshigaya-shi (JP)

(21) Appl. No.: 15/260,646

(22) Filed: Sep. 9, 2016

(30) Foreign Application Priority Data
Sep. 18, 2015 (JP) 2015-184840

(51) Int. Cl. H04N 7/18; H04N 5/77; G02C 11/00; G06F 3/01

(52) U.S. Cl. CPC H04N 7/185; G06F 3/013; G06F 3/012; H04N 5/772; G02C 11/10

(57) ABSTRACT

An image recording system including a user wearable device which includes a visual field direction detection unit which detects a user's visual field direction, and an imaging device which includes an imaging unit which captures an image and is external to the user wearable device, in which a computing device in one of the user wearable device and the imaging device is operable to function as an image processing unit which performs predetermined image processing on the image captured by the imaging unit based on the user's visual field direction.

### CROSS-REFERENCE TO RELATED APPLICATION

This application is based upon and claims the benefit of priority from the prior Japanese Patent Application No. 2015-184840, filed Sep. 18, 2015, the entire contents of which are incorporated herein by reference.

### BACKGROUND OF THE INVENTION

1. Field of the Invention

The present invention relates to an image recording system, a user wearable device, an imaging device, an image processing device, an image recording method and a storage medium.

2. Description of the Related Art

In recent years, wearable-type imaging devices are becoming prevalent by which photographing can be easily performed by a digital camera mounted on the head or body during activities such as sports, cycling, mountain hiking, and walking. Some of these wearable-type imaging devices include, in particular, an imaging device (digital device) that is mounted on the head to photograph scenery that the user is viewing.

For example, Japanese Patent Application Laid-Open (Kokai) Publication No. 2013-200633 discloses a device where a camera device mounted in an eyeglasses-type wearable device captures images (including still images and moving images) of a view in a direction in which the user is watching.

### SUMMARY OF THE INVENTION

In accordance with one aspect of the present invention, there is provided an image recording system comprising: a user wearable device which includes a visual field direction detection unit which detects a user's visual field direction; and an imaging device which includes an imaging unit which captures an image and is external to the user wearable device, wherein a computing device in one of the user wearable device and the imaging device is operable to function as an image processing unit which performs predetermined image processing on the image captured by the imaging unit based on the user's visual field direction.

In accordance with another aspect of the present invention, there is provided a user wearable device comprising: a visual field direction detection unit which detects a user's visual field direction; and a communication unit which transmits information indicating the user's visual field direction to an external device, wherein the external device includes: an acquisition unit which acquires an image, and a computing device which is operable to function as an image processing unit which performs predetermined image processing on the image acquired by the acquisition unit based on the information indicating the user's visual field direction transmitted by the communication unit, and wherein the user wearable device is independent from the external device.

In accordance with another aspect of the present invention, there is provided an imaging device comprising: an imaging unit which captures an image; a communication unit which receives a user's visual field direction transmitted from an external user wearable device; and a computing device which is operable to function as an image processing unit which performs predetermined image processing on the image captured by the imaging unit based on the user's visual field direction, wherein the imaging device is independent from the external user wearable device.

In accordance with another aspect of the present invention, there is provided an image processing device comprising: a visual field direction acquisition unit which acquires a user's visual field direction in a user wearable device that is independent from an imaging device; and a computing device which is operable to function as units comprising: an image acquisition unit which acquires an image captured by the imaging device, and an image processing unit which performs predetermined image processing on the image captured by the imaging device, based on the user's visual field direction acquired by the visual field direction acquisition unit.

In accordance with another aspect of the present invention, there is provided an image recording method comprising: detecting a user's visual field direction by a visual field direction detection unit provided in a user wearable device; capturing an image by an imaging unit provided in an imaging device that is external to the user wearable device; and performing predetermined image processing on the image captured by the imaging unit based on the user's visual field direction, by an image processing unit provided in one of the user wearable device and the imaging device.

In accordance with another aspect of the present invention, there is provided a non-transitory computer-readable storage medium having a program stored thereon, wherein the program is executable by a computer in a user wearable device to perform functions comprising: detecting a user's visual field direction, wherein the program is executable by a computer in an imaging device that is external to the user wearable device to perform functions comprising: capturing an image, and wherein the program is executable by one of the computer in the user wearable device and the computer in the imaging device to perform functions comprising: performing predetermined image processing on the captured image based on the user's visual field direction.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the structure of a mount-type image recording system 1 according to an embodiment of the present invention;

FIG. 2 is a block diagram showing the structure of a head mount device 10 according to a first embodiment;

FIG. 3 is a block diagram showing the structure of a camera device 20 according to the first embodiment;

FIG. 4 is a flowchart for describing the operation of the head mount device 10 according to the first embodiment;

FIG. 5 is a flowchart for describing the operation of the camera device 20 according to the first embodiment;

FIG. 6 is a flowchart for describing the operation of a camera device 20 according to a second embodiment; and

FIG. 7 is a flowchart for describing a replay operation according to the second embodiment.

### DETAILED DESCRIPTION OF THE PREFERRED EMBODIMENTS

Embodiments of the present invention will hereinafter be described with reference to the drawings.

### A. First Embodiment

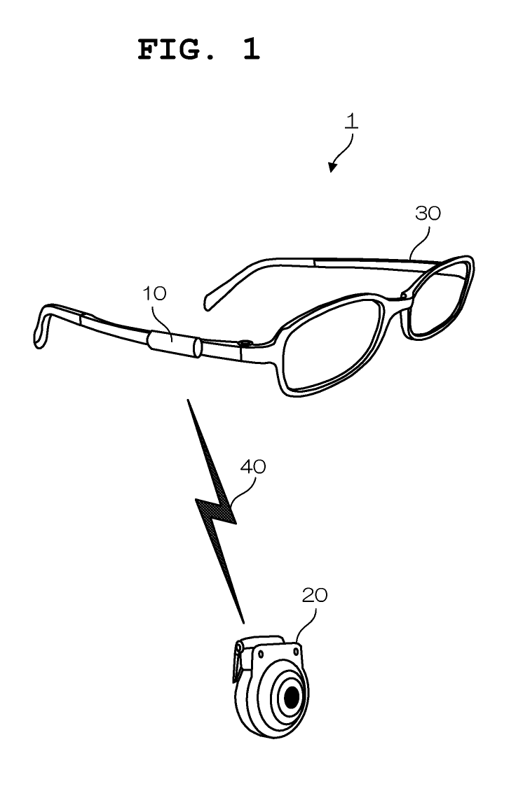

FIG. 1 is a block diagram showing the structure of a mount-type image recording system 1 according to a first embodiment of the present invention. In FIG. 1, the mount-type image recording system 1 includes a head mount device (a device that is worn by a user) 10 and a camera device 20. The head mount device 10 is worn on the head of a photographer via an eyeglass frame 30 or the like so as to detect the photographer's visual field direction during the capturing of an omnidirectional (whole-sky) image (including a wide-angle image) and transmit it to the camera device 20 as additional information. Note that the head mount device 10 may be mounted on the eyeglass frame 30 or may be directly worn on the head with an adhesive sheet, pin, or the like or via a headband, hat, headgear, headphone (earphone), or the like.

The camera device 20 is a digital camera capable of capturing an image at a wide angle (for example, equal to or larger than 180 degrees). In the following descriptions, an example is described in which the camera device 20 captures an omnidirectional image (still image or moving image). The camera device 20 is worn on the body of the photographer (can be hung from the neck as a pendant), the clothes, a bag, or the like such that the imaging direction is oriented to the front of the photographer.

The head mount device 10 and the camera device 20 are connected by using communication means 40 usable by each device, which is wireless communication such as wireless LAN (WiFi) or Bluetooth (registered trademark), or wire communication. In the following example, this connection is made by wireless communication.

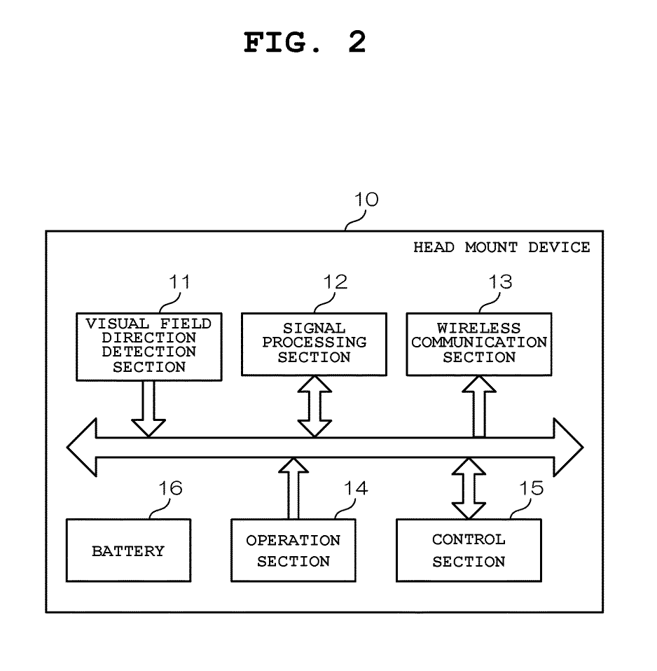

FIG. 2 is a block diagram showing the structure of the head mount device 10 according to the first embodiment. In FIG. 2, the head mount device 10 includes a visual field direction detection section 11, a signal processing section 12, a wireless communication section 13, an operation section 14, a control section 15, and a battery 16.

The visual field direction detection section 11 detects the visual field direction of a user (photographer) wearing the head mount device 10. This visual field direction detection section 11 is constituted by, for example, an azimuth sensor (that detects the east, west, south, and north directions) and triaxial acceleration sensor (that detects inclination), and may include head direction detecting means which detects a direction in which the head of the user (photographer) is oriented or, in place of the head direction detecting means, viewing direction detecting means which detects the movement of the eyeballs of the user (photographer) or detects a positional relation between a reference point (inner canthus) and the iris, the position of a pupil, or the like. Also, both of the head direction detecting means and the viewing direction detecting means may be used to more accurately detect a visual field direction. The signal processing section 12 performs signal processing on the visual field direction (observing direction) of the photographer detected by the field direction detection section 11 for conversion into additional information in a predetermined data format.

The wireless communication section 13 sequentially transmits additional information subjected to signal processing by the signal processing section 12 to the camera device 20 by using a predetermined wireless method (such as wireless LAN or Bluetooth (registered trademark)). As a result of this configuration, it is possible to uniquely identify to which time point (frame) of captured images the visual field direction of the photographer corresponds.

Note that a configuration may be adopted in which transmissions between the head mount device 10 and the camera device 20 are collectively performed at predetermined timing (for example, after the end of photographing) by, for example, time codes that are added to a moving image file being shared. In this configuration, even when a connection failure has occurred in communication between the head mount device 10 and the camera device 20, a correspondence between the above-described additional information (visual field direction of the photographer) and a frame of a moving image file can be identified.

The operation section 14 includes a power supply switch, a photographing instruction switch (shutter), and the like. The photographing instruction switch (shutter) should preferably be a touch sensor or the like although a mechanical switch can be used. In a structure where a mechanical switch has been adopted, a relatively large force is applied. Accordingly, in the case where the head mount device 10 has been mounted on eyeglasses or the like, the eyeglasses may slip off due to this large force, which makes the user feel uncomfortable. Thus, by a touch sensor that is operable with a relatively small force being adopted, the user can operate this photographing instruction switch (shutter) only with a light touch on the housing of the head mount device 10. The control section 15 controls the operation of each section described above by integrative control. The battery 16 is formed of a primary battery, a rechargeable secondary battery, and the like to supply electric power to each section.

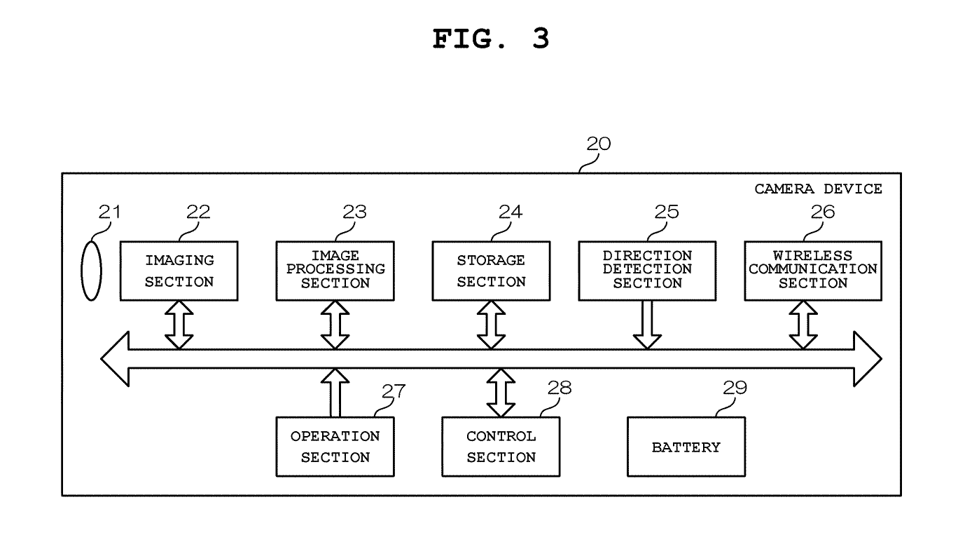

FIG. 3 is a block diagram showing the structure of the camera device 20 according to the first embodiment. In FIG. 3, the camera device 20 includes an optical system (wide-angle lens) 21, an imaging section 22, an image processing section 23, a storage section 24, a direction detection section (imaging direction detection section) 25, a wireless communication section 26, an operation section 27, a control section 28, and a battery 29.

The optical system (wide-angle lens) 21 is a lens (for example, fisheye lens) by which an image at an angle substantially equal to or wider than the viewing angle of a person that is a photographer (horizontally at substantially 200 degrees and vertically at substantially 125 degrees) can be captured, so that an omnidirectional image (still image or moving image) of a view in the front of the photographer can be captured. The imaging section 22 is constituted by an image sensor and the like, and converts an omnidirectional image formed through the optical system (wide-angle lens) 21 into an electrical signal.

The image processing section 23 performs image processing (such as pixel interpolation processing, γ correction, generation of a luminance color-difference signal, white balance processing, exposure correction processing, and filtering processing) on omnidirectional image data. The storage section 24 is used as a buffer memory which temporarily stores omnidirectional image data acquired by the imaging section 22 and subjected to image processing by the image processing section 23 or a working memory which stores programs required for controlling each section and data required for controlling each section.

The direction detection section 25 detects the imaging direction of the camera device 20. This direction detection section 25 is constituted by, for example, an azimuth sensor (that detects the east, west, south, and north directions) and a triaxial acceleration sensor (that detects inclination) so as to detect to which direction among the east, west, south, north, up, down, left, and right directions the camera device 20 has been oriented. The wireless communication section 26 uses a predetermined wireless method (such as wireless LAN or Bluetooth (registered trademark)) to receive additional information (the photographer's visual field direction) from the head mount device 10.

Also, the image processing section 23 calculates an image of a view in the photographer's visual field direction within the photographing range (omnidirectional image) of the camera device 20, based on additional information (the photographer's visual field direction) from the head mount device 10 and the imaging direction of the camera device 20 detected by the direction detection section 25, and trims the image of the view in the photographer's visual field direction from the data of a captured omnidirectional image such that it has predetermined size. The predetermined size herein refers to a size in which the trimmed image data can be displayed on a general display device (since the image data itself can be enlarged and reduced, the size refers to a size determined taking into consideration the amount of data at the time of transfer, processing performance required for enlargement and reduction, and the like). Note that, since the omnidirectional image is more distorted in a more peripheral portion, the distortion may be removed by performing distortion correction processing on the trimmed image. The trimmed image data is stored in the storage section 24. Note that the viewing angle of the camera device 20 may be changed by the user as appropriate with predetermined settings. Then, as a matter of course, when an image of a view in the photographer's visual field direction is to be trimmed into a predetermined size, this image of the view in the photographer's visual field direction may be calculated in consideration of the set viewing angle of the camera device 20 based on information regarding the viewing angle, additional information from the head mount device 10, and information regarding the imaging direction of the camera device 20 detected by the direction detection section 25.

Also, in a case where an image to be acquired is an image of a view in a direction in which the photographer is facing and photographing is performed at a viewing angle equivalent to or larger than the viewing angle of the photographer, the imaging direction of the camera device 20 which is detected by the direction detection section 25 is not necessarily required to be acquired, and the image of the view in the photographer's visual field direction may be calculated only from additional information from the head mount device 10.

The operation section 27 is constituted by a power supply switch, a photographing instruction switch (shutter), and the like. The control section 28 controls the operation of each section described above by integrative control.

An operation of giving an instruction to start photographing, that is, a shutter operation may be performed by the operation section 14 of the head mount device 10 or the operation section 27 of the camera device 20. When a photographing instruction is provided from the head mount device 10, a signal indicating that a shutter operation has been performed is transmitted to the camera device 20 via the communication means 40. Similarly, when a photographing instruction is provided from the camera device 20, a signal indicating that a shutter operation has been performed is transmitted to the head mount device 10 via the communication means 40.

In both cases, in synchronization with each other, the head mount device 10 sequentially detects the photographer's visual field directions and transmits the detected directions to the camera device 20, and the camera device 20 sequentially detects imaging directions of the camera device 20 and performs omnidirectional image (still image or moving image) capturing. In still-image capturing, the detection of the visual field direction of the photographer and the detection of the imaging direction of the camera device 20 are performed only once. However, in moving-image capturing, these detection operations are sequentially performed at predetermined time intervals (for example, for each frame).

Next, the operation of the above-described first embodiment is described.

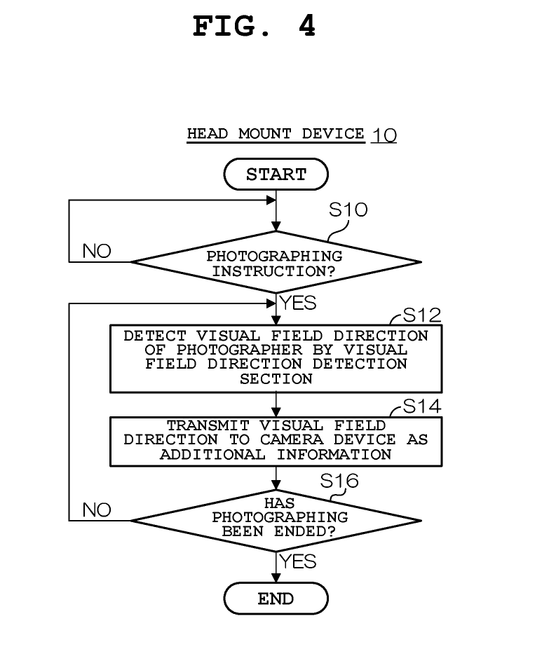

FIG. 4 is a flowchart for describing the operation of the head mount device 10 according to the first embodiment. In the head mount device 10, the control section 15 first judges whether or not a photographing instruction from the operation section 14 operated by the user or from the camera device 20 has been received (Step S10). When no photographing instruction has been provided (NO at Step S10), the control section 15 repeats Step S10 in a standby state (or ends the processing).

Conversely, when a photographing instruction has been provided (YES at Step S10), the control section 15 causes the visual field direction detection section 11 to detect the visual field direction of the photographer wearing the head mount device 10 (Step S12). Next, the control section 15 causes the signal processing section 12 to perform signal processing on the photographer's visual field direction detected by the visual field direction detection section 11 for conversion into additional information in a predetermined data format, and transmits the additional information to the camera device 20 via the wireless communication section 13 (Step S14).

Next, the control section 15 judges whether the photographing has been ended (Step S16). When the photographing has not been ended, that is, in the case of moving-image photographing (NO at Step S16), the control section 15 returns to Step S12 to repeat the detection of the photographer's visual field direction by the visual field direction detection section 11 and the transmission of additional information to the camera device 20. On the other hand, when the photographing has been ended (YES at Step S16), the control section 15 ends the processing.

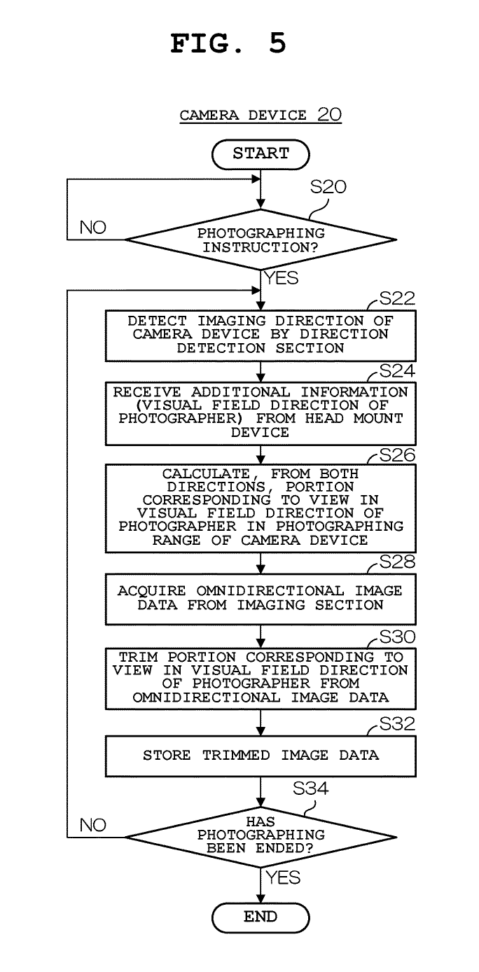

FIG. 5 is a flowchart for describing the operation of the camera device 20 according to the first embodiment. In the camera device 20, the control section 28 first judges whether or not a photographing instruction from the operation section 27 operated by the user or from the head mount device 10 has been received (Step S20). When no photographing instruction has been provided (NO at Step S20), the control section 28 repeats Step S20 in a standby state (or ends the processing).

Conversely, when a photographing instruction has been provided (YES at Step S20), the control section 28 causes the direction detection section 25 to detect the imaging direction of the camera device 20 (Step S22). Next, the control section 28 receives additional information (a direction in which the photographer is facing) from the head mount device 10 via the wireless communication section 26 (Step S24).

Next, based on the imaging direction of the camera device 20 and the visual field direction of the photographer, the control section 28 calculates an image of a view in the photographer's visual field direction within the photographing range (omnidirectional image) of the camera device 20 (Step S26). Next, the control section 28 acquires an omnidirectional image captured by the imaging section 22 (Step S28), and causes the image processing section 23 to trim the image of the view in the photographer's visual field direction from the data of the captured omnidirectional image such that it has a predetermined size (Step S30). Then, the control section 28 stores the trimmed image data in the storage section 24 (Step S32).

Next, the control section 28 judges whether the photographing has been ended (Step S34). When the photographing has not been ended, that is, in the case of moving-image photographing (NO at Step S34), the control section 28 returns to Step S22 to repeat the operation of trimming and storing an image of a view in the photographer's visual field direction from the data of a captured omnidirectional image, based on the imaging direction of the camera device 20 and the visual field direction of the photographer. Conversely, when the photographing has been ended (YES at Step S34), the control section 28 ends the processing.

Note that, in the case of still images, trimmed image data can be replayed as it is as still image data. Also, in the case of moving images, moving image data is generated from trimmed image data each time trimmed image data is stored, or moving image data are collectively generated after the end of photographing. Also, a configuration may be adopted in which, in the case of moving images, a moving image is generated as still images are trimmed, and the moving image data generated during the photographing is stored after the end of the photographing.

According to the above-described first embodiment, since the head mount device 10 which detects the visual field direction of the photographer and the camera device 20 capable of photographing an omnidirectional image are separately provided, the head mount device 10 can be made lighter and smaller, which reduces a burden on a user wearing the head mount device 10.

Also, although the head mount device 10 and the camera device 20 are separately provided, because of the configuration where an image of a view in the visual field direction of the photographer is trimmed from an omnidirectional image captured by the camera device 20, still images and moving images of a view in the visual field direction of the user can be captured as in the case of a wearable-type imaging device having a head mount device 10 and a camera device 20 integrated together.

### B. Second Embodiment

Next, a second embodiment of the present invention is described.

In the second embodiment, an image of a view in the visual field direction of a photographer is not trimmed from an omnidirectional image captured by the camera device 20. In the second embodiment, the visual field direction of the photographer is linked as metadata to the data of a captured omnidirectional image and stored. Then, at the time of replay, the visual field direction of the photographer is acquired from the omnidirectional image data, and an image of a view in the visual field direction of the photographer is trimmed from the omnidirectional image data for replay and display. Here, as the replay device, for example, a smartphone having an application for replay installed thereon or a dedicated terminal is used.

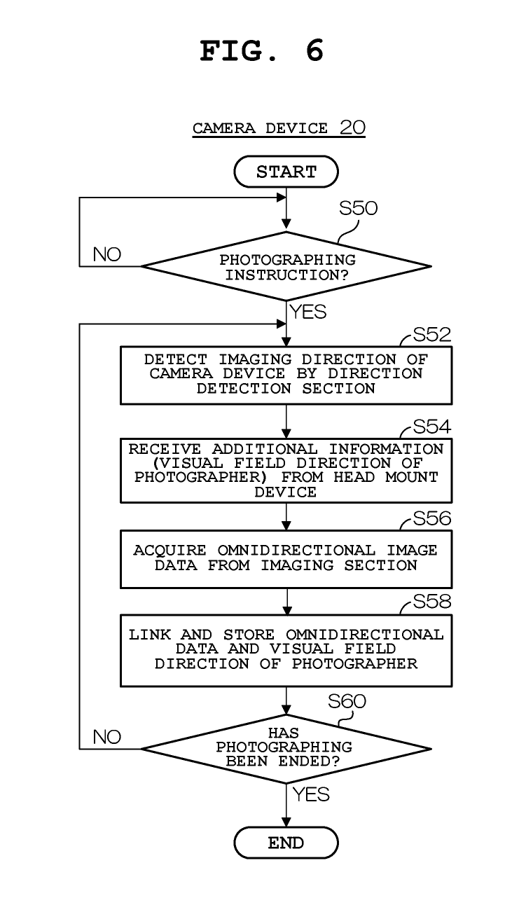

FIG. 6 is a flowchart for describing the operation of the camera device 20 according to the second embodiment. The operation of the head mount device 10 is the same as that of the first embodiment, and therefore is not described herein.

In the camera device 20, the control section 28 first judges whether or not a photographing instruction from the operation section 27 operated by the user or from the head mount device 10 has been received (Step S50). When no photographing instruction has been provided (NO at Step S50), the control section 28 repeats Step S50 in a standby state (or ends the processing).

Conversely, when a photographing instruction has been provided (YES at Step S50), the control section 28 causes the direction detection section 25 to detect the imaging direction of the camera device 20 (Step S52). Next, the control section 28 receives additional information (the visual field direction of the photographer) from the head mount device 10 via the wireless communication section 26 (Step S54).

Next, the control section 28 acquires an omnidirectional image captured by the imaging section 22 (Step S56), links the additional information (visual field direction of the photographer) to the captured omnidirectional image data, and stores the resultant data in the storage section 24 (Step S58).

Next, the control section 28 judges whether the photographing has been ended (Step S60). When the photographing has not been ended, that is, in the case of moving-image photographing (NO at Step S60), the control section 28 returns to Step S52 to repeat the operation of linking additional information (the visual field direction of the photographer) to omnidirectional image data acquired from the camera device 20 and storing the resultant data in the storage section 24. Conversely, when the photographing has been ended (YES at Step S60), the control section 28 ends the processing.

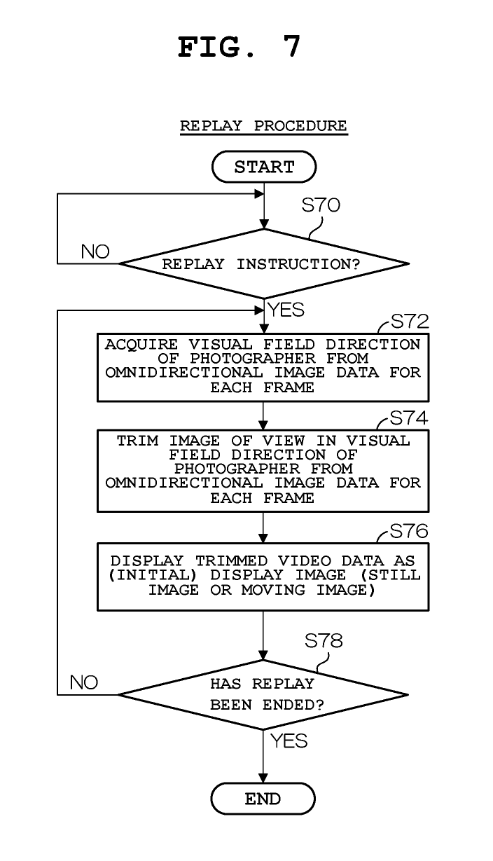

FIG. 7 is a flowchart for describing the operation of replaying omnidirectional image data generated by using a mount-type image recording system 1 according to the second embodiment. Note that this operation is described based on an assumption that omnidirectional image data generated in the camera device 20 has been transferred to a replay device (omitted in the drawings) in advance. The replay device first judges whether a replay instruction has been provided (Step S70). When no replay instruction has been provided (NO at Step S70), the replay device repeats Step S70 in a standby state (or ends the processing).

Conversely, when a replay instruction has been provided (YES at Step S70), the replay device acquires additional information (the visual field direction of the photographer) from omnidirectional image data for each frame (Step S72). Next, the replay device trims an image of a view corresponding to the visual field direction of the photographer from the omnidirectional image data for each frame (Step S74).

Then, the replay device displays the trimmed image data as a (initial) display image (still image or moving image) (Step S76). Next, the replay device judges whether an instruction to end the replay has been provided (in the case of a moving image, it judges whether the image has been replayed to the last) (Step S78). When no replay ending instruction has been provided (in the case of a moving image, when the image has not been replayed to the last) (NO at Step S78), the replay device returns to Step S72 to repeat the operation of trimming an image of a view corresponding to the visual field direction of the photographer from omnidirectional image data for each frame and displaying the image as a display image (still image or moving image). Conversely, when an instruction to end the replay has been provided (in the case of a moving image, when the image has been replayed to the last) (YES at Step S78), the replay device ends the processing.

In the above-described second embodiment, since image processing such as trimming is not performed at the time of the recording of an omnidirectional image, a load at the time of recording can be reduced, and high-quality images can be stored with an increased frame rate or bit rate at the time of recording.

Also, in the above-described first and second embodiments, the light-weight and small-sized head mount device 10 is mounted on the eyeglass frame 30, so that the design quality can be improved, and the head mount device 10 can be mounted without giving a sense of incongruity or an uncomfortable feeling to the user.

Moreover, in the above-described first and second embodiments, since the visual field direction of the photographer is detected based on the direction of the head of the photographer, the visual field direction of the photographer can be detected with a relatively simple structure.

Furthermore, in the above-described first and second embodiments, since the visual field direction of the photographer is detected based on the visual field direction of the photographer in addition to the direction of the head of the photographer, the direction in which the photographer is watching can be more accurately detected, and an image of a view in the visual field direction of the user can be more accurately captured.

In the above-described first and second embodiments, because the orientation of the body of a photographer where the camera device 20 is worn may be changed during photographing, an image to be trimmed is specified based on a directional difference between the head mount device 10 and the camera device 20. However, in a situation where the orientation of the camera device 20 does not change, such as when the camera device 20 has been mounted on a fixture (for example, not the body of the user but a predetermined object such as a tripod), it is possible to specify a portion to be trimmed based only on a visual field direction detected by the head mount device 10, by setting the direction of the camera device 20 as a reference. Accordingly, in this case, the camera device 20 does not require the direction detection section 25.

Also, in the above-described embodiments, the camera device 20 is worn facing the front of the photographer. However, the present invention is not limited thereto. In a case where the area of an image of a view in a direction where the photographer is watching can be confirmed in a captured image based on an imaging direction detected by the direction detection section 25 and the photographer's visual field direction detected by the visual field direction detection section 11 of the head mount device 10, the camera device 20 may be worn on the user with it facing a direction other than the front of the photographer.

Moreover, in the above-described first and second embodiments, an image of a view corresponding to the visual field direction of the photographer is eventually trimmed from an omnidirectional image and stored or displayed. However, the image processing is not limited to trimming, and image processing for adding an image effect may be performed, such as enlargement processing of enlarging a trimmed image, color processing of changing the color of a trimmed image, addition processing of adding an attention line toward the center to the periphery of a trimmed image, and processing of performing enlargement display of an image of a view in a visual field direction without trimming. As a result, an image which attracts user's interest can be provided.

Furthermore, in the above-described first embodiment, image photographing and storage means such as electronic circuits including an image sensor, a LSI (Large-Scale Integration) for image processing, and a memory and a battery for driving the electronic circuits are provided in the camera device 20 which is independent from the head mount device 10. However, the present invention is not limited thereto. For example, these means may be partially mounted on the head mount device 10. For example, at least one or both of the image processing section 23 and the storage section 24 may be mounted on the head mount device 10. That is, as compared to a conventional technology where the camera device 20 is entirely incorporated in the head mount device 10, if the components of the camera device 20 are partially incorporated in a component other than the head mount device 10, the head mount device 10 can be made lighter and smaller, and a burden on the user can be reduced.

Still further, in the above-described embodiments, information regarding the photographer's visual field direction detected by the head mount device 10 is transmitted to the camera device 20. However, the present invention is not limited thereto and a configuration may be adopted in which information regarding a visual field direction and information regarding an imaging direction are transmitted to an image processing device that is not the head mount device 10 or the camera device 20, image data acquired by photographing by the camera device 20 is also transmitted to this image processing device, and this image processing device calculates an image of a view in the visual field direction of the photographer and performs predetermined processing on the image data such as trimming. That is, a configuration may be adopted in which information regarding an imaging direction is transmitted from the camera device 20 to the image processing device at Step S22 in the flowchart of FIG. 5 in the first embodiment and the processing from Steps S24 to S32 is performed by the image processing device. Also, a configuration may be adopted in which information regarding an imaging direction is transmitted from the camera device 20 to the image processing device at Step S52 of FIG. 6 in the second embodiment and the processing from Step S54 to S58 of FIG. 6 and Step S70 to Step S78 of FIG. 7 is performed by the image processing device.

Yet still further, in the above-described embodiments, the head mount device 10 includes the visual field direction detection section 11 which detects the photographer's visual field direction and its accompanying signal processing section 12, wireless communication section 13, and the like, thereby achieving a light weight and a small size. However, the present invention is not limited thereto, and image data (still image or moving image) generated by trimming by the camera device 20 may be directly projected onto the eyes of the user, or a display device for projecting the image data onto a small screen at the front of the user may be provided. Even if a display device is provided to the head of the photographer as described above, because components for a camera function are incorporated in the camera device 20 which is independent from the head mount device 10, it is possible to capture an image of a view in the user's visual field direction while achieving a light weight and a small size, as compared to a wearable device that is entirely mounted to the head.

Yet still further, in the above-described first and second embodiments, the visual field direction of the photographer is detected by the visual field direction detection section 11 of the head mount device 10. However, as long as the orientation of the head of the photographer can be identified, the device is not specifically limited to be mounted on the head, and a structure may be adopted in which the device is mounted on the body and detects the visual field direction of the photographer. For example, a structure may be adopted in which a visual field direction is detected by detecting the movement of muscles which reacts to the movement of the head or by directly detecting the movement of the head by using a sensor or the like.

While the present invention has been described with reference to the preferred embodiments, it is intended that the invention be not limited by any of the details of the description therein but includes all the embodiments which fall within the scope of the appended claims.

What is claimed is:

1. An image recording system comprising:
a user wearable device which includes a visual field direction detection unit which detects a user's visual field direction; and
an imaging device which includes an imaging unit which captures an image and is external to the user wearable device,
wherein a computing device in one of the user wearable device and the imaging device is operable to function as an image processing unit which performs predetermined image processing on the image captured by the imaging unit based on the user's visual field direction.

2. The image recording system according to claim 1, wherein the imaging device includes an imaging direction detection unit which detects an imaging direction of the imaging unit, and
wherein the image processing unit performs the predetermined image processing on the image captured by the imaging unit, based on the user's visual field direction and the imaging direction of the imaging unit.

3. The image recording system according to claim 1, wherein the imaging device is worn on the user such that an imaging direction of the imaging unit is oriented to front of the user.

4. The image recording system according to claim 1, wherein the user wearable device is mounted on eyeglasses worn by the user.

5. The image recording system according to claim 1, wherein the visual field direction detection unit includes a head direction detection unit which detects a direction of the user's head.

6. The image recording system according to claim 1, wherein the visual field direction detection unit includes a viewing direction detection unit which detects a viewing direction of the user.

7. The image recording system according to claim 1, wherein the image processing unit includes a trimming processing unit which trims an image of a view in the user's visual field direction from the image captured by the imaging unit, as the predetermined image processing.

8. The image recording system according to claim 1, wherein the user wearable device further includes a display unit which displays the image captured by the imaging unit.

9. The image recording system according to claim 1, wherein a storage unit which stores the image subjected to the image processing by the image processing unit is provided in the imaging device.

10. The image recording system according to claim 1, wherein the imaging unit continuously captures images at a viewing angle at least substantially equivalent to or wider than a viewing angle of the user at predetermined timings.

11. The image recording system according to claim 1, wherein the imaging unit captures an image at a viewing angle at least substantially equivalent to or wider than a viewing angle of the user.

12. The image recording system according to claim 1, wherein the imaging unit captures the image based on a predetermined operation performed on the user wearable device.

13. A user wearable device comprising:
a visual field direction detection unit which detects a user's visual field direction; and
a communication unit which transmits information indicating the user's visual field direction to an external device,
wherein the external device includes:
an acquisition unit which acquires an image, and
a computing device which is operable to function as an image processing unit which performs predetermined image processing on the image acquired by the acquisition unit based on the information indicating the user's visual field direction transmitted by the communication unit, and
wherein the user wearable device is independent from the external device.

14. An imaging device comprising:
an imaging unit which captures an image;
a communication unit which receives a user's visual field direction transmitted from an external user wearable device; and
a computing device which is operable to function as an image processing unit which performs predetermined image processing on the image captured by the imaging unit based on the user's visual field direction,
wherein the imaging device is independent from the external user wearable device.

15. An image processing device comprising:
a visual field direction acquisition unit which acquires a user's visual field direction in a user wearable device that is independent from an imaging device; and
a computing device which is operable to function as units comprising:
an image acquisition unit which acquires an image captured by the imaging device, and
an image processing unit which performs predetermined image processing on the image captured by the imaging device, based on the user's visual field direction acquired by the visual field direction acquisition unit.

16. The image processing device according to claim 15, wherein the visual field direction acquisition unit includes a communication unit which receives the user's visual field direction transmitted from the user wearable device.

17. The image processing device according to claim 15, wherein the image processing device is a user wearable device, and
wherein the visual field direction acquisition unit acquires a visual field direction of a user wearing the user wearable device.

18. An image recording method comprising:
detecting a user's visual field direction by a visual field direction detection unit provided in a user wearable device;
capturing an image by an imaging unit provided in an imaging device that is external to the user wearable device; and
performing predetermined image processing on the image captured by the imaging unit based on the user's visual field direction, by an image processing unit provided in one of the user wearable device and the imaging device.

19. A non-transitory computer-readable storage medium having a program stored thereon,
wherein the program is executable by a computer in a user wearable device to perform functions comprising:
detecting a user's visual field direction,
wherein the program is executable by a computer in an imaging device that is external to the user wearable device to perform functions comprising:
capturing an image, and
wherein the program is executable by one of the computer in the user wearable device and the computer in the imaging device to perform functions comprising:
performing predetermined image processing on the captured image based on the user's visual field direction.
